(19) United States
(12) Patent Application Publication
(10) Pub. No.: US 2002/0124095 A1
(43) Pub. Date: Sep. 5, 2002

(54) Apparatus and method for sending point-to-point protocol over ethernet

(76) Inventor: Israel Daniel Sultan, Paris (FR)

Correspondence Address: MICHAEL C. CESARANO, SUNTRUST INTERNATIONAL CENTER, 28TH FLOOR, 1 S.E. 3RD AVENUE, MIAMI, FL, 33131-1714, US

(21) Appl. No.: 09/798,432

(22) Filed: Mar. 2, 2001

(51) Int. Cl. G06F 15/16

(52) U.S. Cl. 709/230

(57) ABSTRACT

A method of using point-to-point protocol (PPP) to transmit information from a device connected to an ethernet network, comprises the steps of identifying each packet having an IP header that is transmitted from the device, analyzing each IP packet to determine whether a TCP packet has been encapsulated within a PPP packet within the IP packet, and, if so, determining whether the SYN flag within the header of the TCP header is set, and if the SYN flag is set, modifying the value of the Maximum Segment Size in the TCP header to be no larger than 1452 bytes, and transmitting said packet to the destination address appearing in said IP header.

### FIELD OF THE TECHNOLOGY

This invention relates to computer networks and specifically to a method of transmitting and receiving information using Point-to-Point Protocol (“PPP”) over an ethernet network.

### BACKGROUND OF THE INVENTION

Ethernet is a low-layer network protocol for local area networks (LANs) that defines the characteristics of ethernet networks. Ethernet lies at the base of the DoD (Department of Defense) protocol model associated with TCP/IP, in the network access layer (roughly corresponding to the physical and data link layers of the open systems interconnection (“OSI”) model). Ethernet frames (“packets”) transport data carried in higher level protocols across ethernet networks. Ethernet accepts information formatted by upper level protocols such as IP, ARP (address resolution protocol), and ICMP (internet control message protocol), and “encapsulates” it for delivery across the ethernet network.

Ethernet is a multiple access network in which many devices may be attached to the same physical transmission medium. In ethernet networks, each device can “hear” all transmissions by all devices attached to the network that take place over the medium. In order to avoid collisions between devices transmitting simultaneously over the medium, ethernet uses a protocol, Carrier Sense Multiple Access with Collision Detection (“CSMA/CD”), for determining when a device may transmit a frame. Pursuant to this protocol, each device must first listen and, if no other device is transmitting, may then transmit. If two devices should begin transmitting simultaneously, each will detect a collision, and both will immediately cease transmitting. After a random wait, either device may begin transmitting again.

Because each device on an ethernet network must be able to be uniquely distinguished from the others, each is identified by a globally unique physical address, sometimes referred to as a “medium access control”, or “MAC” address. When a frame is to be delivered across the network, the sending device inserts the destination device's address in the destination address of the frame and places it on the network, where it maybe examined by all devices. The device that recognizes its own address in the destination address field receives the frame. Ethernet also supports two other categories of addressing: “Broadcasting” uses a standard broadcast address (FF FF FF FF FF FF in hexadecimal) by which any device on the network can communicate with all other devices on the network simultaneously. “Multicasting” is used where a device on the network sends a frame to a group, but not all, of the other devices on the network.

Ethernet frames maybe of varying length. Each ethernet frame includes a preamble consisting of 8 bytes (as used herein, a “byte” shall consist of 8-bits), destination address and source addresses, each being 6 bytes in length, a 2 byte field that may provide either a type designation (Ethernet II frame) or the length of the LLC data field (IEEE 802.3 frame), a data field that may have between 46 and 1500 bytes, and a 4-byte frame check sequence. An Ethernet II frame may be distinguished from an IEEE 802.3 frame by analyzing the 2-byte “type” or “length” frame. If the value in that field is “1536” or larger (0x0600 in hexadecimal), the number refers to a frame type, and the frame is an Ethernet II frame; if smaller than “1536,” the field provides a data field length, and is an IEEE 802.3 frame. The maximum permissible length of an ethernet frame (which, by convention, does not include the preamble, but which does include a trailing 4-byte Frame Check Sequence) is 1518 bytes.

Information formatted in higher level protocols, such as IP, TCP, or PPP, may be contained within the ethernet frame's data field, or “payload.” All information associated with packets from upper layer protocols, including their headers, must fit within the 1500 byte limit of the ethernet payload.

The suite of protocols known as TCP/IP (“Transmission Control Protocol/Internet Protocol”) is the protocol used to carry information over the internet. TCP/IP is also used in many LANs that are, or may be connected, to the internet. TCP/IP is particularly well suited for ethernet networks, having been developed shortly after the development of ethernet. The IP portion of TCP/IP is a network layer protocol that supports TCP and other higher layer protocols such as UDP (“user datagram protocol”) and ICMP (“internet control message protocol”). IP uses a header that includes the source and destination addresses of the sending and recipient devices in the now familiar 32-bit format: xxx.xxx.xxx.xxx. The basic IP header is 20 bytes in length, although the addition of options in an “Options” field may extend the length past 20 bytes. Most options for an IP header are rarely used, other than possibly for diagnostic purposes. Because of this, an IP header will have a length of 20 bytes except under the most unusual conditions.

An IP packet may be fragmented in accordance with the Fragmentation Flags and the Fragmentation Offset that constitute part of the basic IP header. Fragmentation of an IP packet may be required where a packet's length exceeds the “maximum transmission unit” (“MTU”) for a network. However, there are situations in which packet fragmentation is not desired. Within the design of IP, every network has a maximum packet size, designated MTU, and the MTU may be different for different networks. MTU is determined as a function of network design, including network bandwidth, maximal diameter, and desired imposed jitter. Since an IP packet in transit will frequently traverse more than a single network, it may encounter more than one MTU. In situations in which fragmentation is undesirable, it may be necessary to use a path MTU discovery algorithm to determine the smallest MTU that will be encountered during transit, and to establish a maximum packet size based upon that information.

TCP is a protocol located above IP, in the transport layer. TCP embodies an architecture having all of the functionality required to implement reliability, sequencing, flow control, and streaming necessary for an end-to-end signaling model. TCP provides a communication channel between processes on each host system. It does this by communicating through a “socket,” which is bound to a TCP port address, and which acts as the interface between the process and the network.

The basic TCP header is 20 bytes in length, and relies upon the IP packet within which it is encapsulated to provide source and destination device addresses. The TCP header includes source and destination ports, and other information needed to place packets in sequence, to control packet fragmentation, to acknowledge receipt of a packet, to verify the integrity of information, to signal various conditions, and to carry out other functions. The TCP header may also contain options which, when present, will vary the length of the TCP header. A TCP packet for “opening” a socket for communications will set a flag bit to signal a SYN (synchronize) condition, and will include other information that will be used in the session associated with the socket being opened. Once the socket has been opened, and throughout the session until the socket is closed (by setting a bit in the FIN flag) the TCP parameters for communicating with the socket will remain as they were established when the socket was opened.

A number of options can be carried in a TCP header. One of those options is a maximum segment size (“MSS”) value which occupies 4 bytes of the TCP options field (2 bytes identify the option as MSS and two bytes represent the number of bytes for the maximum segment size). When set, this number limits the number of bytes that may constitute the TCP payload throughout the session. The MSS value can be set only in the initial SYN packet. Other options, such as the Window Scale option and the SACK (“selective acknowledgment) are also available only in an initial SYN packet. Thus, once a TCP socket has been opened, it is unlikely that any other options will be presented, and the TCP header will remain at a constant length of 20-bytes throughout the session.

The point-to-point protocol (“PPP”) is a set of interdependent protocols that work together to support the concurrent operation of multiple higher-layer protocols over a PPP serial link. PPP is an IETF (Internet Engineering Task Force) Standard specified in RFC-1661. PPP provides a standard for transporting such higher-layer protocols between two points by encapsulating higher-layer data along with negotiation mechanisms for configuring the link. PPP is probably best known for use in telephone or ISDN dial-up links between individual computers and internet service providers (“ISPs”) who provide a connection to the internet. Data formatted for IP (“internet protocol”) is encapsulated within a PPP packet for delivery from the individual computer to the ISP. At the ISP, the encapsulation will be stripped away, and the IP packet will be delivered to the internet for further transmission to its destination.

Because PPP was developed as a protocol to connect two “peer” devices, it lends itself to methods of access control, billing functionality, and type of service demands. These features and controls, although desirable under particular circumstances, are specific to “two-party” networks, and are not available in traditional ethernet networks. Unlike ethernet networks, PPP, being a two-party network, does not have multiple device addressing capability, and has not been suitable for use by multiple hosts, or to conduct PPP sessions to multiple destinations.

Recent efforts have led to the development of a method for transmitting PPP over ethernet networks. These efforts are described in RFC-2516 which, although not an internet standard, proposes a method for transmitting PPP over Ethernet (“PPPoE”) by encapsulating PPP packets within ethernet packets to provide many of the benefits associated with each of the protocols. The PPPoE header for an ethernet frame is 6 bytes long, and includes a Session ID (2 bytes), the version and frame type (1 byte), a “code” field that is used when initiating a PPPoP session (1 byte), and a length field (2 bytes). The payload of a PPPoE packet includes a PPP packet, whose header is 2 bytes in length, and any other packets that may be encapsulated within the PPP packet. Optional “tags” attached to the PPPoE packet are carried in the payload section, and may further reduce the maximum PPP payload size. In order to accommodate the PPP packet within the ethernet frame, RFC-2516 provides that the Maximum-Receive Unit (“MRU”) option for the PPP payload must not be larger than 1492 bytes.

While limiting the MRU option to 1492 bytes will result in adequate PPPoE communications across the ethernet network, it has the drawback of requiring the MTU to be individually set or changed at each device that will participate in PPPoE transmissions. Thus, there is a need for an alternative means for limiting the size of the PPP packet within the PPPoE protocol.

### SUMMARY OF THE INVENTION

This invention avoids the drawbacks associated with the use of PPPoE as described in RFC 2516, and allows for adjustment of the overall IP payload size by adjusting the maximum segment size (“MSS”) in the encapsulated TCP packet that opens a connection to a remote socket using a SYN command.

Further encapsulated within a PPP packet using the PPPoE protocol are headers for an IP packet and its payload, and for a TCP packet and its associated payload. When the TCP session is opened, the maximum segment size (“MSS”) option can be used to limit the size of the TCP payload, hence the overall size of the payload that must fit within the ethernet frame. Using the method of this invention, the sending device can add an MSS-length option to each TCP socket opening SYN packet leaving the device, limiting the MSS to 1452 bytes for the session. This limitation is based upon the maximum ethernet payload size (1500), less the total of the PPPoE header (6 bytes), the PPP header (2 bytes), the IP header (20 bytes), and the TCP header (20 bytes), for a maximum segment size of 1492 bytes. The method of this invention examines each TCP SYN packet and changes the value of the number in the MSS field to “1452.” In this way, the data to be included in a PPPoE payload can be limited to no more than 1500 bytes.

### BRIEF DESCRIPTION OF THE DRAWINGS

FIG. 1 is a depiction of an ethernet packet in which is encapsulated an IP packet, a PPPoE packet, a PPP packet, and a TCP packet having an options field.

FIG. 2 depicts an ethernet packet in which is encapsulated an IP packet, a PPPoE packet, a PPP packet, and a TCP packet in which the options field is absent.

### DESCRIPTION OF THE PREFERRED EMBODIMENTS

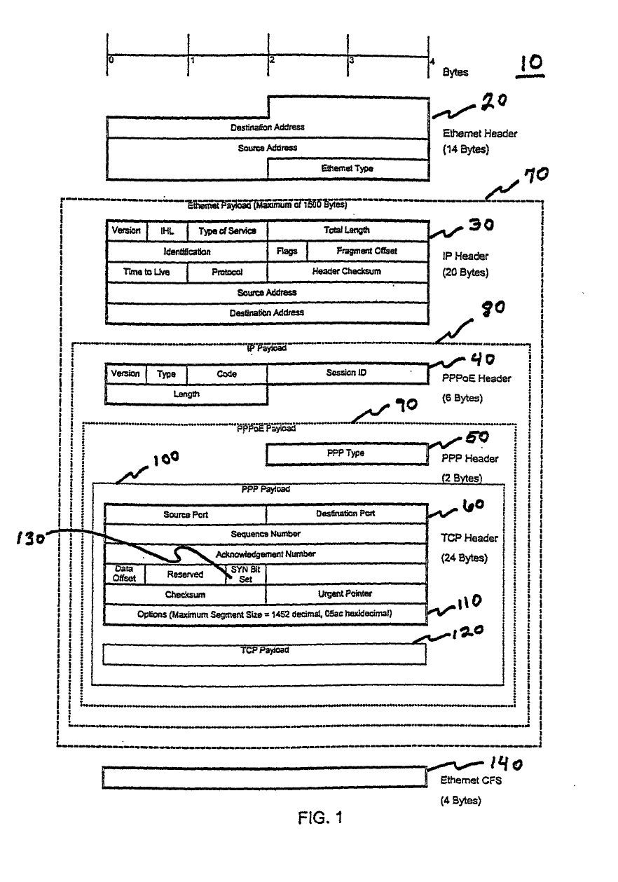

In FIG. 1, an ethernet packet is depicted 10 in which is encapsulated an IP packet, a PPPoE packet, a PPP packet, and a TCP packet. Each packet has a header and a payload associated with it. The ethernet packet header 20 is shown as having a length of 14 bytes. The payload for the ethernet packet 70 includes the entirety of the IP packet. The standard header for the IP packet 30 has a length of 20 bytes, not including optional fields which are not present in FIG. 1. The payload for the IP packet 80 includes the entirety of the PPPoE packet. The header for the PPPoE packet 40 occupies 6 bytes, and has a payload 90 that encompasses the PPP packet. The PPP header 50 is a 2-byte header having as the PPP payload 100 the entire TCP packet. The TCP header 60 includes an options field 110 to hold information for the maximum segment size (“MSS”). As depicted in FIG. 1, the TCP header with the optional 4 byte MSS is 24-bytes in length. In this packet the SYN flag 130 would be set, indicating that a socket is being opened for interprocess communications. The TCP packet has a payload 120 whose maximum size is determined by the MSS value in the TCP options field 110. The TCP payload 120 carries process-specific information from a socket in the sending device to a corresponding socket in the receiving device. A 4-byte trailing frame check sequence (FCS) 140 is appended to the ethernet packet.

The MSS is a 16 bit number that is theoretically may be as large as 65,535. However, because the maximum size for an ethernet payload (not including the ethernet header or trailer) is 1500 bytes, it is clear that any packet in which the size of the ethernet packet, including both the 14 byte header and the 4 byte file check sequence, exceeds 1518 bytes cannot be transmitted over an ethernet medium.

In order to avoid ethernet packet length exceeding 1518 bytes when using PPP, the method of this invention initializes a TCP session by substituting the number” 1452″ (0x05 ac in hexadecimal) into the MSS field when the SYN flag 130 is set in the TCP header. This is shown in FIG. 1 at 110. The value of 1452 is determined by subtracting from the maximum payload value for an ethernet frame (1500 bytes) the number of bytes in the headers of other encapsulated packets. These are, the basic IP header (20 bytes), the PPPoE header (6 bytes), the PPP header(2 bytes), and the basic TCP header (20 bytes). Within a TCP header, the MSS field is one of the possible options that must be included in a TCP packet to “open” a socket for communications. Any such TCP socket opening packet may be identified by the SYN flag 130 in the header, which is set for socket opening frames and otherwise is clear. Although, as shown in FIG. 1, an initialization TCP header will always be larger than 20 bytes, none of the optional fields, including the window scale option and the SACK options, will be needed once the socket has been opened.

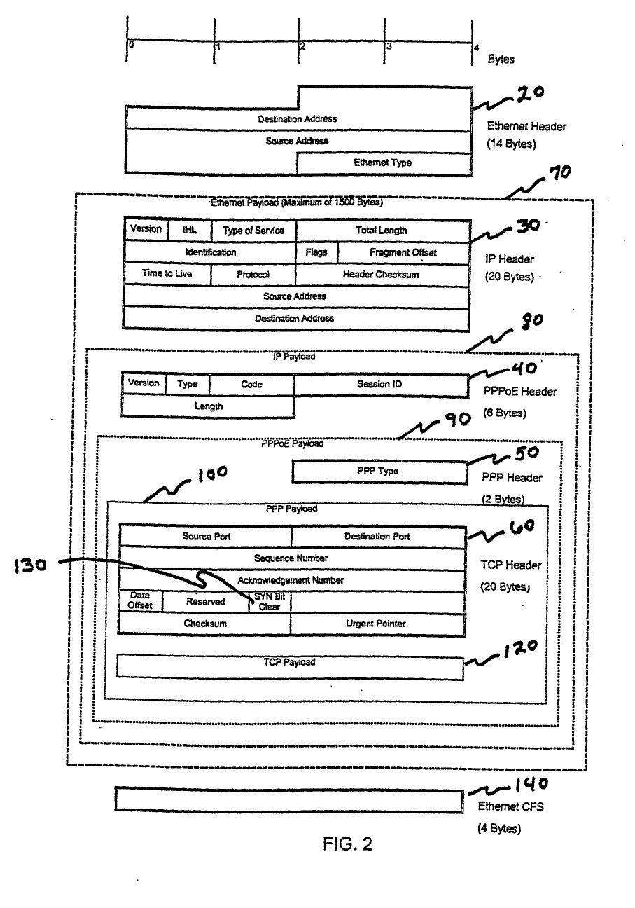

FIG. 2 shows an ethernet packet in which PPP is encapsulated, and the TCP header does not include an options field. Because this packet does not open a socket, the SYN flag 130 in the TCP header will be clear. For non-initializing TCP packets, the basic 20 byte TCP will always precede the TCP payload. (The only other TCP header options are seldom used, as they are primarily diagnostic tools that have been supplanted with better diagnostic mechanisms). Because, as in FIG. 2, the options field will not be present in TCP headers when the SYN flag is cleared, it is possible to rely on a value of 20 bytes for the TCP header. Although the IP header may also have an options field, similar considerations apply, and a value of 20 bytes may be used for the IP header.

The method of this invention can be implemented through software or firmware in any PPPoE session. Implementation may take the form of checking the MSS value for any TCP SYN packet and replacing any MSS value with “1452” if the original MSS value is larger than 1452; or the method could simply write that number into the MSS field for each TCP SYN packet, without bothering to analyze or determine the value that had previously been there.

It will be understood that the description herein relates to the preferred embodiment, and that the scope of the invention as set forth in the following claims is not so limited.

What is claimed is:

1. A method of using point-to-point protocol (PPP) to transmit information from a device connected to an ethernet network, comprising the steps of:
identifying each packet having an IP header that is transmitted from said device;
analyzing each said IP packet to determine whether a TCP packet has been encapsulated within a PPP packet within said IP packet, and, if a TCP packet has been encapsulated within a PPP packet within said IP packet, determining whether the SYN flag within the header of said TCP header is set;
and if said syn flag is set, modifying the value of the maximum segment size in said TCP header to be no larger than the decimal number of 1452 bytes;
transmitting said packet to the destination address appearing in said IP header.

2. A method of using point-to-point protocol (PPP) to transmit information from a device connected to an ethernet network, comprising the steps of:
analyzing each packet transmitted from said device to identify those packets having an IP header;
for each said identified IP packet, further analyzing said packet to identify IP packets containing an encapsulated PPP packet;
for each said identified encapsulated PPP packet, further analyzing said packet to identify PPP packets containing an encapsulated TCP packet;
for each said identified TCP packet, determining whether the TCP header to said packet contains an optional field for a Maximum Segment Size;
if said TCP header does contain an optional field for a Maximum Segment Size, ensuring that the value in said optional Maximum Size Segment field of said TCP header is not greater than the decimal number of 1452 bytes;
placing said packet on said ethernet network for transmission and delivery.

3. The method of transmitting information using point-to-point protocol (PPP) over an ethernet network as claimed in claim 2 in which the SYN flag in said TCP header is analyzed to determine whether said TCP header contains an optional Maximum Segment Size field.

4. The method of transmitting information using point-to-point protocol (PPP) over an ethernet network as claimed in claim 2 in which said value in said Maximum Segment Size is analyzed to determine whether it is larger than the decimal number 1452 and, if said value is larger than said decimal number 1452, substituting said decimal number 1452 into said Maximum Segment Size field.

5. A machine for transmitting information over an ethernet network using point-to-point protocol (PPP), comprising:
means for accepting a TCP formatted packet to be transmitted over said ethernet network;
means for determining whether the header of said TCP formatted packet contains a maximum size segment (MSS) field and, if said TCP header does contain an MSS field, means for setting the value of said MSS field to the decimal number 1452 or smaller;
means for encapsulating said TCP packet within the payload of a PPP packet;
means for encapsulating said PPP packet within the payload of a Point-to-Point Protocol over Ethernet (PPPoE) packet;
means for encapsulating said PPPoE packet within the payload of an IP packet;
means for encapsulating said IP packet within the payload of an ethernet packet;
means for transmitting said ethernet packet to said ethernet network.

6. The machine for transmitting PPP over ethernet as claimed in claim 5 in which said means for determining whether said header of said TCP formatted packet comprises determining whether the SYN flag in the header of said TCP formatted packet is set.

7. The machine for transmitting PPP over ethernet as claimed in claim 5 in which said means for setting the value of said MSS field further comprises determining whether said value of said MSS field is greater than the decimal number 1452 and, if said value is greater than the decimal number 1452, replacing said value with a decimal number equal to or less than 1452.

8. The machine for transmitting PPP over ethernet as claimed in claim 5 in which said means for setting the value of said MSS field further comprises inserting the decimal number 1452 in to said MSS field.
